(19) United States
(12) Patent Application Publication
(10) Pub. No.: US 2017/0180921 A1
(43) Pub. Date: Jun. 22, 2017

(54) DEVICE EQUIPPED WITH MAGNETIC FIELD SENSOR AND SYSTEM AND METHOD FOR USING SAME

(71) Applicant: Ringly Inc., New York, NY (US)

(72) Inventors: John Pelochino, Portland, OR (US); Tim Mason, Mill Valley, CA (US); Christina d'Avignon, New York, NY (US)

(21) Appl. No.: 15/383,677

(22) Filed: Dec. 19, 2016

Related U.S. Application Data
(60) Provisional application No. 62/270,154, filed on Dec. 21, 2015.

(51) Int. Cl. H04W 4/00; H04W 4/06; H04B 1/3827

(52) U.S. Cl. CPC H04W 4/008; H04B 1/385; H04W 4/06

(57) ABSTRACT

A portable electronic device that is capable of existing in a low power usage scanning mode is provided. The device comprises a magnetic field sensor and optionally a signaling assembly that is configured to generate stimuli. The device may be used to link brick and mortar stores with e-commerce platforms.

### CROSS-REFERENCE TO RELATED APPLICATION

This application claims the benefit of the filing dates of U.S. provisional patent application Ser. No. 62/270,154, filed Dec. 21, 2015, the entire disclosure of which is incorporated by reference.

### FIELD OF THE INVENTION

The present invention relates to wireless devices for use in commerce.

### BACKGROUND OF THE INVENTION

Mobile communication devices such as smartphones, tablets, and personal digital assistants have become commonplace in the twenty-first century. People rely on these devices to communicate with business associates, friends, and family. Because of the prevalence of these devices, society has recognized that they are an integral part of the ways in which people do and will continue to connect with each other.

Recently, there has been a trend to develop systems that couple wireless communication devices together, e.g., smartphones and fashion accessories that are configured to receive communications. In these systems, an example of which is described in WO 2014/130946, Mobile Communication Devices, published Aug. 28, 2014, when a smartphone receives an in-coming message from a remote source, the smartphone is able to send instructions to the fashion accessory that direct the fashion accessory to produce an output. The output may, for example, comprise one or more of a visual stimulus, an auditory stimulus, or a tactile stimulus.

The current uses for these devices and systems remain largely personal. Accordingly, most users interact with these types of fashion accessories in order to become alerted to a message unobtrusively, and for these users, the fashion accessory is a terminal point of wireless communication. Thus, usually it receives but does not transmit information. While the industry has been focusing on the use of smartphones as the intermediary between these fashion accessories and contacts of the users, the applicant has both appreciated that the fashion accessories themselves could be used to receive input directly from sources other than the user's smartphone or tablet and invented new and non-obvious devices, systems, and methods for doing so.

### SUMMARY

Various embodiments of the present invention provide portable electronic devices, methods for using these devices and systems that incorporate these devices. These portable electronic devices may, for example, be designed to be worn by a person or to adorn a person's clothing or to be contained within such items, and the methods and systems may be used to create a wireless bridge between brick and mortar stores and e-commerce platforms.

According to a first embodiment, the present invention provides a portable electronic device comprising: (a) a sensor, wherein the sensor is capable of detecting a magnetic field from a remote device when the portable electronic device is in a scanning mode; (b) a wireless transceiver; and (c) a microcontroller, wherein the portable electronic device is capable of existing in a data retrieval mode, and wherein when in the data retrieval mode, the portable electronic device is capable of retrieving data wirelessly from the remote device.

According to a second embodiment, the present invention provides a system for wireless communication comprising a first component and a second component, wherein the first component is the portable electronic device of any of the embodiments of the present invention and the second component is a remote device, wherein the second component comprises: (a) an element that is capable of generating a magnetic field, for example, a magnet; (b) a remote device wireless transceiver; and (c) one or both of a microcontroller and a non-volatile memory, wherein the second component is configured to broadcast the data at one or more predetermined times or regular or irregular intervals, wherein the data comprises: (i) unique identification information that corresponds to the second component or an item associated with the second component; and (ii) system identification information that indicates that the second component is part of the system.

According to a third embodiment, the present invention provides a system for wireless communication comprising a first component and a plurality of second components, wherein the first component is the portable electronic device of any of the embodiments of the present invention and each second component comprises: (a) an element that is capable of generating a magnetic field; (b) a remote device wireless transceiver; and (c) one or both of a microcontroller and non-volatile memory, wherein each second component is configured to broadcast data at one or more predetermined times or regular or irregular intervals, wherein for each second component the data comprises: (i) unique identification information that corresponds to the second component or an item associated with the second component; and (ii) system identification information that indicates that the second component is part of the system, wherein the system identification information of each second component is the same.

According to a fourth embodiment, the present invention provides a method of engaging in commerce comprising: (a) using a system of an embodiment of the present invention; (b) activating a trigger module, wherein the trigger module is housed within a first component that is a portable electronic device of the present invention and the trigger module is configured to be activated when the first component is within a predetermined distance of the second component; (c) retrieving unique identification information that is housed within (and/or broadcast by) the second component; (d) storing the unique identification information locally on the first component; and (e) transmitting said unique identification information to a third component, wherein the third component is configured to execute a protocol that transmits over a network, an order for an item or a service.

According to a fifth embodiment, the present invention provides a method of engaging in commerce comprising: (a) activating a first application on a first component of a system described herein to scan for a magnetic field, wherein the first component is a smartphone or a tablet; (b) activating a trigger module, wherein the trigger module is housed within the first component and is capable of being activated when the first component is within a predetermined distance of the second component; (c) retrieving unique identification information from the second component; (d) storing the unique identification information locally on the first component; and (e) activating a second application on the first component, wherein the second application is configured to execute a protocol that transmits over a network, an order for an item or a service. The first and second applications may be separate applications that may be or need to be activated independently or they can or may be modules within the same application.

Through various embodiments of the present invention, one is able to accomplish one or more the following: (1) use ultra-low power proximity detection to initiate a power intensive communication task; (2) perform a selective scan for information or data about an item, thereby saving power and improving effectiveness and efficiency; (3) capture user intention of which item is of interest; (4) provide intuitive user gesture interaction with an item of interest; (5) provide more discrete and accurate proximity detection of a beacon than is possible with RF signaling power; (6) use a wireless switch/trigger based on physical proximity to initiate a power intensive communication task; (7) provide an opportunity for a small wearable device to manage power efficiently while allowing intuitive on-demand wireless interaction with smart tags; and (8) avoid the cumbersomeness of commerce systems that use any one or more of bar codes, QR codes, NFC technologies or BLE technologies.

These and other systems, methods, devices, features, and advantages of the present invention will be apparent to those skilled in the art from the following detailed description of the embodiments and the accompanying figures.

### BRIEF DESCRIPTION OF THE FIGURES

The systems, methods, and devices disclosed and the following detailed description of certain embodiments thereof may be understood by reference to the following figures. Elements in the figures are presented for illustrative purposes, and they are not necessarily drawn to scale.

FIG. 1 depicts components of an embodiment of a device of the present invention.

FIG. 2 depicts an embodiment of a system of the present invention.

FIG. 3 depicts components of an embodiment of a system of the present invention interacting with each other.

FIG. 4 depicts a method of an embodiment of the present invention.

### DETAILED DESCRIPTION

The present invention will now be described in detail through various illustrative, non-limiting embodiments thereof with reference to the accompanying figures. The invention may, however, be embodied in many different forms and should not be construed as being limited to the illustrative embodiments set forth herein. Rather, the embodiments are provided so that this disclosure will be thorough and will fully convey the concept of the invention to those skilled in the art.

Portable Electronic Devices

According to a first embodiment, the present invention is directed to a portable electronic device. The portable electronic device may comprise, consist essentially of or consist of: (a) a sensor; (b) a wireless transceiver; and (c) a microcontroller. The portable electronic device may, for example, be in the form of or may be housed within a fashion accessory such as a ring (or be housed within or part of a mobile communication device such as a smartphone or tablet), and may be capable of receiving information from a plurality of other devices.

In some embodiments, the portable electronic device is a connectable Bluetooth low energy device and is capable of simultaneously: (i) communicating wirelessly with a Bluetooth low energy computing device, wherein the Bluetooth low energy computing device comprises a central processing unit; and (ii) wirelessly retrieving said data from a different remote device. When the portable electronic device is part of a mobile communication device that is configured to receive instructions to generate stimuli, the different functionalities may share a microcontroller or there may be more than one microcontroller. Similarly, these devices may have one or more transceivers.

Sensors

A portable electronic device of the present invention may have a default mode in which it is continuously or continually searching for a magnetic field. This default mode may be referred to as a scanning mode, and in some devices, it is always active when the device has power.

The sensor is the element within the portable electronic devices that is capable of detecting a magnetic field from a remote device when the portable electronic device is in the scanning mode. Thus, it may be referred to as a magnetic field sensor. As persons of ordinary skill in the art are aware, a magnetic field sensor may be in the form of a small-scale microelectromechanical (MEMS) device for detecting and measuring magnetic fields. By way of a non-limiting example, the sensor may comprise one or more of a reed switch, a Hall Effect sensor and a microelectromechanical system switch, e.g., each of a reed switch, a Hall Effect sensor and a microelectromechanical system switch.

By using a magnetic field sensor to determine whether there is proximity to a source of information one imparts accuracy, reliability, and effectiveness to the devices of the present invention. Moreover, these benefits may be realized without using undesirably large levels of power.

In some embodiments, the scanning mode must be activated, and thus the device is not always scanning. The device may be configured such that in order to enter the scanning mode, an instruction must be received. The instruction may, for example, be received from a smartphone or tablet wirelessly coupled to the portable electronic device or through an input mechanism on the portable electronic device itself such as a button or knob. In one embodiment, the portable electronic device is part of a fashion accessory, such as a ring, a bracelet or a watch that has a front face that may be turned or toggled between two positions. A first position may cause the device to be in a scanning mode and a second may cause the device to be in a non-scanning mode.

If a portable electronic device itself contains magnets, e.g., for docking during recharging, the sensor will be selected and/or configured either not to detect those magnets or to treat their fields as background noise and ignored.

Transceiver

The wireless transceiver is configured to receive data packets wirelessly from the remote device when the portable electronic device is in a data retrieval mode. The wireless transceiver may be configured to receive data whenever activated but exist in a sleep state whenever it is not activated or after a predetermined fixed amount of time within the activated state has lapsed.

Microcontroller

The microcontroller is configured to switch the portable electronic device from a scanning mode to a data retrieval mode automatically, and to cause the portable electronic device to exit the data retrieval mode upon the completion of retrieval of information or after a preset time period, or whichever comes first between completion of retrieval of information and the preset time period. Typically, the portable electronic device will require more power to retrieve data than to scan for a magnetic field. Therefore, preferably the portable electronic device is able to minimize the amount of time that it spends in the data retrieval mode. The microcontroller may exist in the form of hardware, software or a combination thereof, and may be configured to conserve energy by limiting time in the data retrieve mode. Further, the microcontroller is coupled to each of the magnetic field sensor and the transceiver.

In some embodiments, when the portable electronic device is in the data retrieval mode it is not in the scanning mode. Alternatively, the portable electronic device is always in the scanning mode, even when in the data retrieval mode. Thus, in the latter case, there is no shutting off of the scanning mode.

The portable electronic device may contain a trigger module that is formed from hardware, software, or a combination of both. The trigger module may be within the microcontroller or coupled to the microcontroller. The trigger module is configured to switch the portable electronic device from the scanning mode to the data retrieval mode upon the occurrence of a trigger event (when they are mutually exclusive modes or to activate the data retrieval mode when they are not mutually exclusive). The trigger event may be the detection of a magnetic field by the sensor element. The sensor element may be selected and/or configured such that it will only detect a certain strength of a magnetic field, or the trigger event may be the detection of a minimum magnetic field. Thus, when it detects a magnetic field above a threshold level, there may be a trigger event such that the trigger module is activated.

In practice, when a vendor sets up magnetic fields in the vendor's store, the vendor will typically use the same size magnetic field for each different potential selection, and based on the combination of the sensor and the power of the magnetic fields, the trigger event may occur when the portable electronic device is within a certain distance of the generator of the magnetic field. In some embodiments, the distance is less than 1 meter, less than 50 centimeters, less than 25 centimeters, less than 10 centimeters, less than 5 centimeters, less than 3 centimeters, less than 1 centimeter, less than 50 mm, less than 10 mm or less than 5 mm.

Although the sensor may detect the magnetic field when it is within a fixed distance of it, the trigger module may be configured such that it does not register a trigger event until the sensor is within that range for more than a certain amount of time, e.g., at least 1 micro second, at least 5 microseconds, at least 10 microseconds, at least 1 second, at least 10 seconds or at least 30 seconds.

The portable electronic device may be configured such that the trigger module is passive, i.e., when a person crosses the threshold distance for the prescribed amount of time, the data transfer to the portable electronic device is accomplished. Alternatively, there may be an active step such that in addition to crossing the threshold and staying there for a prescribed amount of time, the user must activate the transfer of data step through, for example, tapping the portable electronic device or moving it in a predetermined three-dimensional space or by saying a word or phrase. If an active step is required, preferably the portable electronic device is equipped with a sensor, input mechanism, gyroscope, microphone and/or oscillator as needed to detect the input.

Mobile Communication Device

In some embodiments, the portable electronic device is part of or housed within or is attached to a mobile communication device, such as any of the mobile communication devices of WO 2014/130946, Mobile Communication Devices, published Aug. 28, 2014, the entire disclosure of which is incorporated by reference as if set forth fully herein.

In some embodiments, the mobile combination devices comprises: (a) the portable electronic device; (b) a fashion accessory; and (c) a signaling assembly. The microcontroller described above may also be referred to as a microprocessor, and it may be configured to carry out functions in addition to those described above. For example, it may be configured to receive instructions from a wireless device that causes the generation of stimuli as described in WO 2014/130946. When configured to carry out this additional functionality, the microcontroller may be coupled to an antenna an antenna trace. The microcontroller may also interface with the circuitry of a printed circuit board in order to generate stimuli. In some embodiments, the communication received by the microcontroller, from e.g., a smartphone, is the instruction of which stimulus to generate. Thus, analysis of the type of communication and the corresponding stimulus to generate may be done on the transmitting device or on a server or in the cloud and not necessarily by the microcontroller.

The signaling accessory is the hardware that allows the mobile communication device to receive communications and to generate stimuli in response to those communications. If the portable electronic device and the signaling assembly need the same or similar functionality, they may make use of the same hardware, e.g., a transceiver or microcontroller, or there may be different structures for each of these functionalities.

Preferably, the mobile communication device is configured to be portable, i.e., is light enough to be carried, and optionally, contains one or more ornamental designs or aesthetically pleasing features or design elements. The components assembly may be associated with each other by, for example, glue or solder. In some embodiments, the fashion accessory completely encases the signaling assembly and portable electronic device, whereas in other embodiments, the fashion accessory only partially encases each of the signaling assembly and the portable electronic device, e.g., encases at least 50%, at least 60%, at least 70%, at least 80%, at least 90% or at least 95% of each of the signaling assembly and the portable electronic device. When the fashion accessory partially encases the signaling assembly and portable electronic device, preferably they are at least mostly, if not completely, obscured from view when the mobile communication device is worn by a user or adorns a user's clothing.

Fashion Accessories

As noted above, in some embodiments, the mobile communication devices comprise fashion accessories and thus may be worn by a person or used to adorn a person's clothing. These accessories may be purely decorative, or have a utility beyond aesthetics. Examples of these fashion accessories include, but are not limited to, rings, bracelets, necklaces, watches, watch bands, purses, wallets, earrings, body rings, headbands, glasses, belts, ties, tie bars, tie tacks, wallets, shoes, pendants, charms and bobbles. The mobile communication device may also be in the form of other items. For example, the mobile communication device may also be incorporated into pockets, steering wheels, keyboards, pens, and bicycle handles, as well as other objects in which it may be desirable to enjoy the capabilities of the systems, methods, and devices disclosed herein. As persons of ordinary skill in the art will recognize, the inclusion of a signaling assembly is optional, and in some embodiments, the portable electronic device is associated with or contained within a fashion accessory that does not contain a signaling assembly.

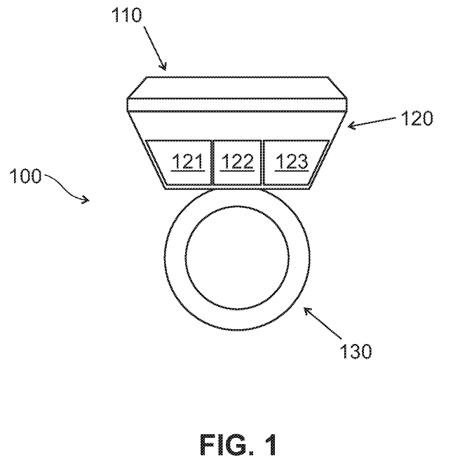

As shown in FIG. 1, in one embodiment, the fashion accessory is a ring 100. The ring may comprise, consist essentially of or consist of a shank 130, which is the location that provides an opening for a finger, and a head 120, which comprises, consists essentially or consists of ornamental features of the ring 110 and in some embodiments houses the sensor 121, the microcontroller 122, and the wireless transceiver 123. Not shown is the signaling assembly, which may also be present.

The head may be of any shape, e.g., a regular sphere, truncated sphere, cube, rectangular prism, cylinder, triangular prism, cone, pyramid, barrel, truncated cone, domed cylinder, truncated cylinder, ellipsoid, regular polygon prism or truncated three-dimensional polygon of e.g., 4-16 sides, such as a truncated pyramid (trapezoid), or combination thereof or it may be an irregular shape.

In some embodiments, the head comprises an upper face that contains and is configured to show one or more jewels and/or ornamental designs. In some of these embodiments, visual stimuli are perceivable through lights in the upper face or around its perimeter. By one non-limiting example, the lights are oriented in a design or are incorporated into the aesthetics of the upper face (and/or other portions) of the fashion element. Thus, if the fashion element is in the form of a human or animal face, head or skull, lights may be situated in the locations of the eyes. In one embodiment, there are LEDs that are designed to look like diamonds in the eyes of the face, head or skull upon receipt of an alert (provided that a signaling assembly is present). Alternatively, the upper face of the ring may have an absence of any elements through which to present visual stimuli in response to communications.

By way of another non-limiting example, the head is a truncated pyramid with its larger portion being proximate to the upper face of the head. In certain embodiments, on each of one, two, three or four sides there are one, two, three, four, five, six, seven or eight LEDs lights. By using a truncated polygon and placing the LEDs only on the side(s) of the truncated polygons, when a visual stimulus is generated, it may be less distracting than were it placed on the upper face. Thus, by way of example, there may be 0-4 or 1-4 LED lights on each of the sides of a truncated polygon. In some embodiments, the angles of the truncated polygon between the sides and the base of the truncated polygon, which may be adjacent to or distal from the shank, are between 30 degrees and 75 degrees or between 40 degree and 60 degrees or between 45 and 90 degrees.

Examples of ring shank sizes are those of standard rings that are currently worn by people, e.g., US sizes 5-15, which include size 6 (approximately 16.51 mm inner diameter); US size 7 (approximately 17.32 mm inner diameter) and US size 8 (approximately 18.14 mm inner diameter). An example of the dimensions of a ring, including the shank and head, is up to 20 mm by 20 mm by 30 mm or up to 40 mm by 40 mm by 40 mm or up to 50 mm by 50 mm by 50 mm.

Materials of which the jewelry may be made include, but are not limited to, gold, platinum, silver, gold micron plated brass, bronze, copper, nickel, plastic, glass and combinations thereof. Stones that may be included in the jewelry head for display include, but are not limited to semi-precious stones such as black onyx, amethyst, labradorite, malachite, garnet, citrine, opal, lapis, tiger's eye, jasper, carnelian, aquamarine, moonstone, jade, peridot, sodalite, topaz, and turquoise of for example, 10 mm by 10 mm to 20 mm by 30 mm across the largest dimensions.

Thus, when the portable electronic device is a fashion accessory such as a piece of jewelry, it may be configured to have at least two distinct functionalities. For example, it may have a first functionality of a mobile communication device in the form of a piece of jewelry, wherein the piece of jewelry comprises an upper face such as a stone and/or ornamental design comprising, consisting essentially of, or consisting of metal, plastic or wood (that in some embodiments is not transparent), and a signaling assembly, wherein the signaling assembly comprises a light emitting diode that is capable of emitting light for a duration of time to create a visual display and the light emitting diode is capable of existing in an on state and an off state, wherein when in the off state, the light emitting diode does not emit light. The signaling assembly is housed within the piece of jewelry and is capable of generating a plurality of different stimuli, wherein the different stimuli are based on receipt of different communications from a device such as a user's smartphone, tablet or computer and at least one of the stimuli is the visual display, wherein the stone or ornamental design on the upper face and the stone is visible both when the light emitting diode emits light (being in an on state) and when the light emitting diode is in an off state. This first functionality is described in detail in WO 2014/130946, Mobile Communication Devices, published Aug. 28, 2014, the entire disclosure of which is incorporated by reference. The second functionality may be that formed by the sensor, transceiver and microcontroller as described in this specification and that enables the devices to scan for and to detect transmission that, for example, allow a user of it to engage in commerce as described in this specification. In some embodiments of the present invention, the device has both functionalities. In other embodiments, the device has only the second functionality.

Signaling Assemblies

As noted above, the signaling assembly of a mobile communication device, when present, may be housed partially or completely within the fashion accessory and is configured to generate one or more sensory stimuli of one or more different types. In some embodiments, sensory stimuli are of different types that are detectable by different senses and thus are emitted through different modalities. In other embodiments, they may be of the same general type, be detectable by the same sense and consequently be emitted through the same modality of the device, but have different patterns, intervals, volumes, colors or configurations or can otherwise be differentiated by a user. The signaling assembly may comprise hardware, software or a combination thereof. Thus, in some embodiments the signaling assembly comprises one or more if not all of a central processing unit (“CPU”), which may be in the form of a microcontroller, a printed circuit board, a battery and one or more stimulus generating output devices. Examples of stimuli generating output devices include but are not limited to light emitting devices, sound emitting devices and generators of tactile stimuli, each of which is a different modality.

In some embodiments, the signaling assembly comprises a flexible circuit board with its components, a battery, a motor, an LED and a microcontroller. In one embodiment, the components are housed in a plastic subassembly such as a polyether ether ketone (“PEEK”), which is an example of an organic thermoplastic and held together by a sheet metal stamped top part. Optionally, the circuit board is coated for water-resistance with Parylene C or Parylene N polymers that can be vapor deposited to provide a thin waterproof coating between 0.1 microns and 2 mm. Alternatively, one may use an epoxy or a resin such as hot glue, and fill a cavity with a non-conductive polymer that sets in place, thereby providing waterproofing, as well as sealing and fixing. In another example, components are created with a sheet metal stamped part.

Batteries

In various embodiments, the portable electronic device comprises a battery, e.g., a 12 mAh battery. Other commercially available batteries that fit within the device may also be used. The battery may be rechargeable or a single use battery. When rechargeable, the battery may be recharged either by removing the battery and recharging it or recharging it while in the mobile communication device. For example, the terminals of the battery may be connected directly to an external charger (and thus, a power supply) or to a USB host such as a computer or laptop. Examples of battery types include, but are not limited to, lithium cell, silver oxide and alkaline cell batteries.

Systems

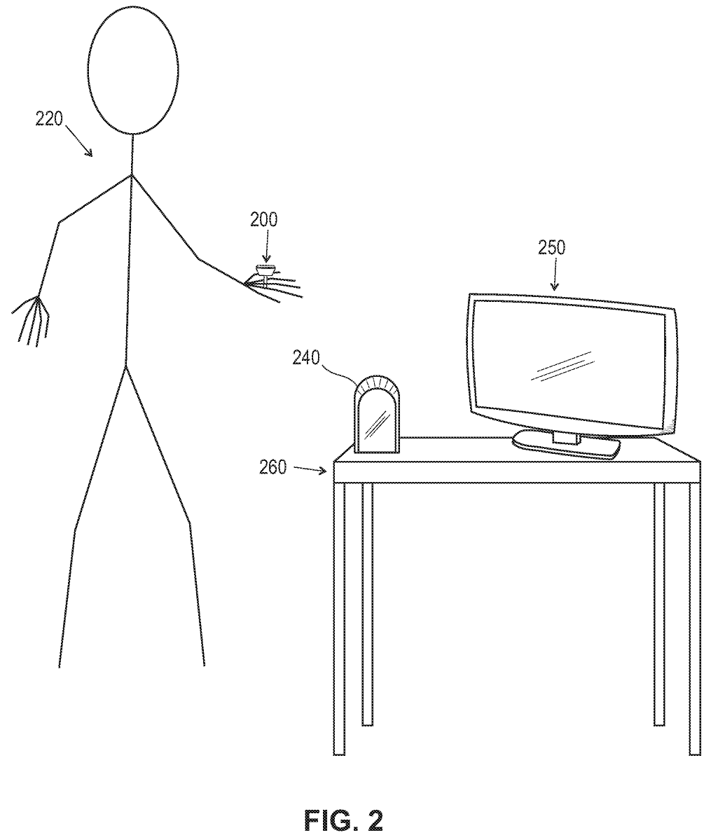

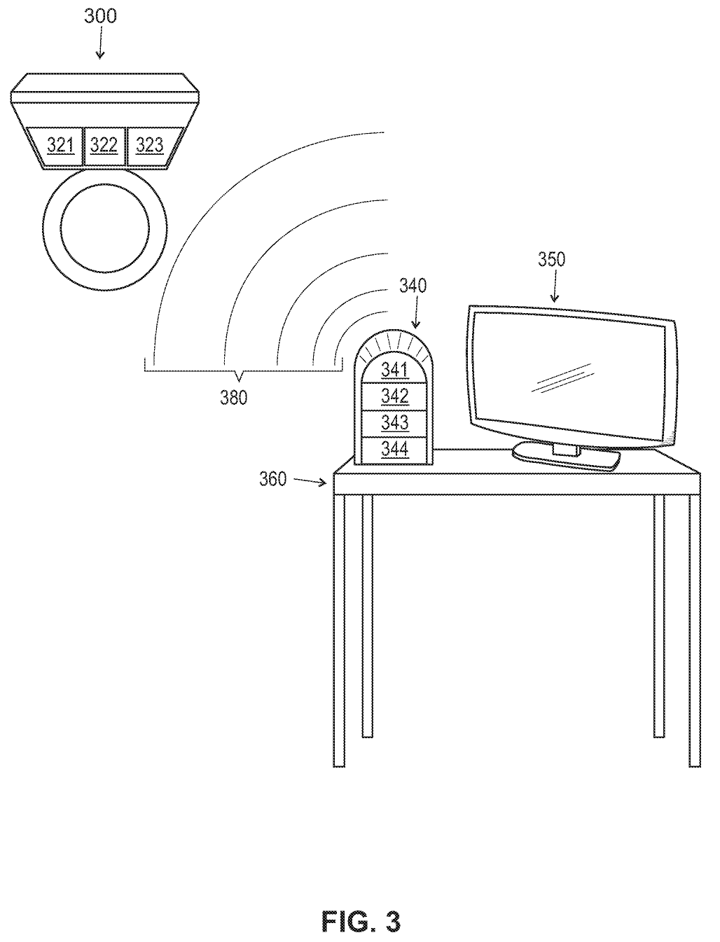

The portable electronic devices of the present invention (and mobile communications devices that contain them) may be part of a system. FIGS. 2 and 3 illustrate such a system and show a remote device that is capable of generating a magnetic field as well as a portable electronic device. In these systems, the portable electronic device may be referred to as a first component and the remote device may be referred to as a second component. The second component may be referred to as a remote device because it is not in wired communication with the first component.

As shown in FIG. 2, a user 220 may wear the first component, which is shown as a ring that houses the portable electronic device 200. The ring may also house a signaling assembly and other hardware that permit wireless communications with a user's tablet or smartphone and allows for the generation of stimuli in response to instructions received from the tablet or smartphone. The second component 240 is shown resting on a table 260 proximate to a flat screen television. The flat screen television is merely an example of a type of good that may be offered. A person of ordinary skill in the art will recognize that any type of good may be offered. Furthermore, the actual good need not be present, a representation, e.g., a poster displaying information about the good, may be present. Similarly, the remote device, which may be a tag, may be proximate to a poster or other representation that describe a service being offered.

As shown in greater detail in FIG. 3 (without the user being shown), the first component 300 houses the sensor 321, the microcontroller 322, and the wireless transceiver 323. The second component 340 is again shown proximate to the good being offered 350 and sitting on top of a table 360. The second component may comprise an element that is capable of generating a magnetic field 380, e.g., a magnet 341, a remote device wireless transceiver 342 and one or both or a microcontroller 343 and a non-volatile memory 344 (both being shown in the figure). As noted, the element that is capable of generating a magnetic field may be a magnet. Alternatively, the second component of the system may use wires so that when they conduct electricity, they generate a magnetic field. If this latter option is used, power must be supplied to the wires to generate the magnetic field.

In some embodiments, the second component may constantly generate a magnetic field but be configured to transmit, through the remote device transceiver, data at one or more predetermined times or regular or irregular intervals. This data comprises: (i) unique identification information that corresponds to the second component or an item (a good or service) associated with the second component; and (ii) system identification information that indicates that the second component is part of the system.

In some embodiments, the second component is in the form of a tag. The tag may be: free standing and proximate to a good or a representation of a good or service. Alternatively, it may be physically affixed to a good or a representation of a good or service.

When a vendor or service provider or other entity that wishes to offer goods and/or services wishes to offer a plurality of goods or services, the vendor or service provider may use a plurality of second components. In these cases, each second component comprises an element that is capable of generating a magnetic field, such as a magnet; a remote wireless transceiver; and one or both of a microcontroller and non-volatile memory. In some embodiments, each second component is configured to transmit or to broadcast data at one or more predetermined times or regular or irregular intervals, wherein for each second component the data comprises: (i) unique identification information that corresponds to the second component or an item associated with the second component; and (ii) system identification information that indicates that the second component is part of the system, wherein the system identification information of each second component is the same. If the second component does not store non-volatile memory, then preferably it is coupled to memory on a device or in the cloud, and this memory stores the date to be transmitted. By broadcasting the data a regular or irregular intervals, the tag is constantly sending out data wirelessly so that should a portable electronic device be in a data retrieval mode and within the zone is which is can record the data, there will be data transfer. The tag may be configured such that its broadcast range is limited, which prevent a portable electronic device from additionally recording data from a nearby tag.

In some embodiments, the second component comprises an alert feature. The alert feature may, for example, be in the form of a visual display or auditory display that indicates when data is being or has been transferred to a portable electronic device. If the feature comprises a visual display, the visual display may, for example, be in the form of an increased illumination level and/or change of color of part or all of the second component and/or an increased illumination level and/or change of color of part or all of the goods to be offered (or representation of the goods and/or services to be offered). Alternatively or additionally, the portable electronic device may contain a display such as one or more LED lights that illuminate to confirm to the user that there has been a transfer of data.

Optionally, the system comprises a third component. The third component may be a computing device such as a personal computer, a networked computer, a tablet or a smartphone. In these embodiments, the first component is capable of wirelessly communicating with the third component. When the system is configured such that portable electronic device is within a mobile communication device that comprises a signaling assembly, the third component can not only receive information from the portable electronic device that the portable electronic device received from the remote device, but also the third component can independently transmit information to the signaling assembly to generate stimuli as described above and in WO 2014/130946.

Methods

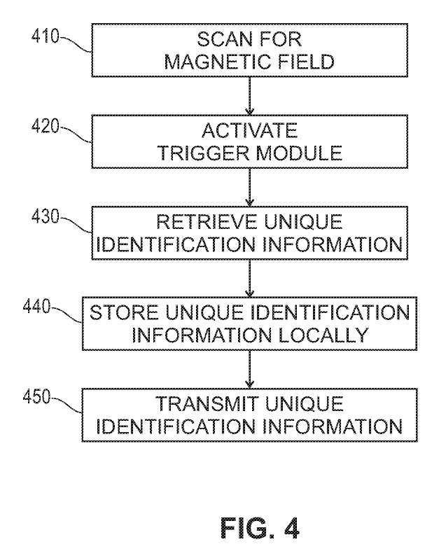

Various embodiments of the present invention provide methods for engaging in e-commerce. In one method, which may be illustrated in part by FIG. 4, a user wears a first component, e.g., in the form of jewelry, and the first component (the portable electronic device within the jewelry) is either in the scanning mode or put into the scanning mode 410.

The user approaches a tag that is generating a magnetic field. When the user's portable electronic device comes within a threshold distance of the tag, the magnetic field activate the trigger module 420. Thus, there has been a trigger effect. In some embodiments, the portable electronic device will need to remain within this proximity for a certain amount of time for there to have been a trigger effect.

After the trigger module has been activated, through the transceiver on the portable electronic device, the unique identification information of a product associated with the tag is retrieved 430. The portable electronic device stores this information locally 440, and then transmits the unique identification information to a smartphone 450. Because each of the first component and the second component has a transceiver, there is a plurality of ways that information can be transferred. For example, the second component may continually broadcast its data. The transceiver on the first component may verify that the broadcast data is part of the same system of which it is a part and then record the data that identifies an object to be purchased. Alternatively, the second component may continuously or continually transmit only data that indicates the system of which it is a part. Next, the first component may verify that it is configured to receive data from the second component, send a data packet requesting the product information, and at that point, the second component transmits that information.

In an alternative embodiment, the first component is a smartphone or tablet. In this embodiment, the user activates a first application on the first component. This application scans for a magnetic field.

Next, upon detection of a magnetic field, a trigger module is activated. The trigger module is housed within the first component and is capable of being activated when the first component is within a predetermined distance of the second component. Then, the first component retrieves the unique identification information from the second component and stores the unique information locally on said first component. Finally, it activates a second application on the first component, wherein the second application is configured to execute a protocol that transmits over a network, an order for an item or a service.

In any of these methods, the user's smartphone or tablet may automatically execute a protocol that causes an item or service to be purchased so that it truly is one step shopping. Alternatively, the smartphone or tablet is configured to create or to make use of a shopping cart based on the activity of the user, and at a later time, the user can review the cart, modify it and complete a purchase.

### EXAMPLES—PROPHETIC

### Example 1

In one system, these are the following two components:

Component 1: A wearable device in the form of a ring is equipped with a MEMS magnetic switch. The wearable device also includes a BLE SoC (transceiver and mcu), battery, vibrating motor, LED, supporting electronics and FW (firmware), and ring base and gemstone. The wearable device is a connectable BLE peripheral (designed to connect with a smart phone, tablet, computer, or other device with BLE central capabilities) and simultaneously can act as a scanning BLE central to read advertising BLE peripherals within RF range.

Component 2: A tag is equipped with disk magnet (rare-earth, N42). The tag also includes a BLE SoC (transceiver and mcu), battery, supporting electronics and FW, and enclosure. The tag is a non-connectable BLE peripheral that advertises (also referred to as broadcasts) information at a set interval (the interval is adjustable by the vendor), part of the data/information identifies the tag as specific for the system of which the ring is a part, and part of the data/information uniquely identifies the tag. Additional specific information about the vendor, time of the data transfer, location, etc., can be placed in the advertising packet. By including this additional information, when the user's smartphone processes it, the smartphone will be able to determine readily through which vendor to process an order.

Component 2 is situated on Point-of-Purchase stands (retail), directly on hard goods, directly on soft goods and textiles, at/on landmarks, beside objects of interest (i.e., pieces/objects/installations in museum and other private and public spaces), on information placards, on people, and/or on animal pet/livestock tags.

Component 1 maintains a connection with a smart phone over BLE as a peripheral. When Component 1 is brought within ˜10 mm of Component 2, Component 1 senses the magnet field and triggers Component 1 to start scanning as a BLE central and look for advertising BLE (Bluetooth low energy) peripherals within range. It looks for the tag (Component 2) and, if found, it verifies that the tag is very close using BLE RSSI (radio frequency signal strength). If Component 1 finds a Component 2 that is a tag and very close, it pulls the unique identification information from the advertising packet from Component 2, stores it locally and if in a connection with a BLE central device, sends this information to the BLE central, e.g., a smartphone of the user.

### Example 2

In another example, a system has the following two components:

Component 1: Devices such as tablets or smartphone are equipped with magnetometers, which typically measure magnetic fields for three physical axes. For example, any modern iPhone or Android phone. These devices also need to support BLE functionality.

Component 2: Same as listed in Example 1.

Component 1 will run an App code that senses the magnet field via standard BLE interface (iOS and Android) libraries and the data feeds regarding the strength of any magnet field within reasonable proximity of the device. Component 1 may either be in this reading state continually or be triggered by geofences. It could also be triggered manually.

When Component 1 is brought within ˜10 mm of Component 2, Component 1 senses the magnet field and triggers Component 1 to start scanning as a BLE central and look for advertising BLE peripherals within range. It looks for a tag (Component 2) and, if found, it verifies the tag is very close using BLE RSSI.

Various aspects of the present invention have been described for use in connection with one or more embodiments. However, unless explicitly stated or otherwise apparent from context, each feature described above in any one embodiment may be used in connection with any and all embodiments.

What is claimed is:

1. A portable electronic device comprising:
(a) a sensor, wherein the sensor is capable of detecting a magnetic field from a remote device when the portable electronic device is in a scanning mode;
(b) a wireless transceiver; and
(c) a microcontroller,
wherein the portable electronic device is capable of existing in a data retrieval mode, and wherein when in the data retrieval mode, the portable electronic device is capable of retrieving data wirelessly from the remote device.

2. The portable electronic device of claim 1, wherein said portable electronic device is configured to use less power when in the scanning mode than when in the data retrieval mode.

3. The portable electronic device of claim 2 further comprising a trigger module, wherein the trigger module is configured to switch the portable electronic device from the scanning mode to the data retrieval mode.

4. The portable electronic device of claim 3, wherein the trigger module is configured to be activated when the portable electronic device is within a distance of 500 mm of the remote device and when activate to switch the portable electronic device from the scanning mode to the data retrieval mode.

5. The portable electronic device of claim 4, wherein the trigger module is configured to be activated when the portable electronic device is within said distance for at least 5 micro seconds.

6. The portable electronic device of claim 5, wherein the sensor comprises a reed switch, a Hall Effect sensor and a microelectromechanical system switch.

7. The portable electronic device of claim 5, wherein the portable electronic device is wearable by a person.

8. The portable electronic device of claim 5, wherein the portable electronic device is housed in a piece of jewelry.

9. The portable electronic device of claim 8, wherein the jewelry is a ring or a bracelet.

10. The portable electronic device of claim 5, wherein the portable electronic device is a smartphone or a tablet.

11. The portable electronic device of claim 1, wherein the portable electronic device is a connectable Bluetooth low energy device and is capable of simultaneously: (i) communicating wirelessly with a Bluetooth low energy computing device, wherein the Bluetooth low energy computing device comprises a central processing unit; and (ii) retrieving said data from said remote device.

12. The portable electronic device of claim 1, wherein said portable electronic device is housed in a mobile communication device that further comprises a signaling assembly, wherein the signaling assembly is capable of generating a visual stimulus in response to data received wirelessly from a device other than the remote device.

13. A system for wireless communication comprising a first component and a second component, wherein the first component is the portable electronic device of claim 1 and the second component is the remote device, wherein the second component comprises:
(a) an element, wherein the element is capable of generating the magnetic field;
(b) a remote device wireless transceiver; and
(c) one or both of a microcontroller and a non-volatile memory,
wherein the second component is configured to broadcast the data at one or more predetermined times or regular or irregular intervals, wherein the data comprises: (i) unique identification information that corresponds to the second component or an item associated with the second component; and (ii) system identification information that indicates that the second component is part of the system.

14. The system of claim 13, wherein the second component comprises both the microcontroller and the non-volatile memory.

15. The system of claim 13 further comprising a third component, wherein the first component is capable of wirelessly communicating with the third component and the third component is a smartphone, a tablet or a personal computer.

16. The system of claim 13, wherein the first component is in the form of wearable jewelry and the second component is in the form of a tag.

17. The system of claim 13, wherein the portable electronic device further comprises a trigger module, wherein the trigger module is capable of being activated when the first component is within a predetermined distance of the second component, and when said trigger module is activated, said first component is capable of retrieving the unique identification information and storing said unique identification information locally on the portable electronic device.

18. The system of claim 13, wherein the element is a magnet.

19. The system of claim 13, wherein the portable electric device is housed in a fashion accessory that comprises a signaling assembly, wherein the signaling assembly is capable of generating a visual stimulus in response to data received wirelessly from a device other than the second component.

20. A system for wireless communication comprising a first component and a plurality of second components, wherein the first component is the portable electronic device of claim 1 and each second component comprises:
(a) an element, wherein the element is capable of generating the magnetic field;
(b) a remote device wireless transceiver; and
(c) one or both of a microcontroller and non-volatile memory,
wherein each second component is configured to transmit the data at one or more predetermined times or regular or irregular intervals, wherein for each second component the data comprises: (i) unique identification information that corresponds to the second component or an item associated with the second component; and (ii) system identification information that indicates that the second component is part of the system, wherein the system identification information of each second component is the same.

21. The system of claim 20, wherein the element is a magnet.

22. A method of engaging in commerce comprising:
(a) using the first component of the system of claim 13 to scan for the magnetic field;
(b) activating a trigger module, wherein the trigger module is housed within the first component and is configured to be activated when the first component is within a predetermined distance of the second component;
(c) retrieving the unique identification information;
(d) storing said unique identification information locally on said first component; and
(e) transmitting said unique identification information to a third component, wherein the third component is configured to execute a protocol that transmits over a network, an order for an item or a service.

23. The method of claim 22, wherein the first component is a piece of jewelry and the second component is a tag, wherein the tag is associated with a sample of said item or a representation of said item.

24. A method of engaging in commerce comprising:
(a) activating a first application on the first component of the system of claim 13 to scan for the magnetic field, wherein the first component is a smartphone or a tablet;
(b) activating a trigger module, wherein the trigger module is housed within the first component and is capable of being activated when the first component is within a predetermined distance of the second component;
(c) retrieving the unique identification information from the second component;
(d) storing said unique identification information locally on said first component; and
(e) activating a second application on the first component, wherein the second application is configured to execute a protocol that transmits over a network, an order for an item or a service.
